(19) United States
(12) Patent Application Publication
(10) Pub. No.: US 2023/0294580 A1
(43) Pub. Date: Sep. 21, 2023

(54) ARMREST FOR VEHICLE

(71) Applicant: SHINKI INTER-MOBIL CO., LTD., Busan (KR)

(72) Inventors: Kyoung Sik KIM, Ansan-si (KR); Sang Jin JOUNG, Ulsan (KR); Hong Kil NOH, Asan-si (KR)

(21) Appl. No.: 17/848,931

(22) Filed: Jun. 24, 2022

(30) Foreign Application Priority Data
Mar. 15, 2022 (KR) 10-2022-0031876

(51) Int. Cl. B60N 2/75

(52) U.S. Cl. CPC B60N 2/793

(57) ABSTRACT

Disclosed herein is an inner cover of an armrest for a vehicle. The armrest includes a center lid for opening and closing a storage box, and a pair of side lids for supporting the center lid on both sides of the center lid. The side lid comprises an outer cover mounted on the outside, and an inner cover mounted on the inside, and a horizontal protrusion protruding inward. At least a part of the center lid is positioned on the horizontal protrusion. The upper frame of the metal frame is mounted between the outer cover and the inner cover to increase a structural strength.

### CROSS-REFERENCE TO REPLATED APPLICATIONS

The present application is based upon and claims the benefit of priority to Korean Patent Application No. 10-2022-0031876 filed on Mar. 15, 2022, in the Korean Intellectual Property Office, which is incorporated herein by reference in its entirety.

### BACKGROUND OF THE INVENTION

### Field of the Invention

The present invention relates to an armrest for a vehicle and, more specifically, to an armrest for a vehicle, which can provide sufficient structural strength and various functions through a design of inner covers of side lids of the armrest.

### Background Art

In general, a console is installed between a driver seat and a passenger seat of a vehicle. Such a console includes a storage box mounted at a lower part and an armrest for opening and closing the upper portion of the storage box. Moreover, the armrest includes side lids fixed to both sides of the storage box located at the lower part, and a center lid mounted between the side lids to be opened and closed.

In substance, the center lid of the armrest opens and closes a storage room inside the storage box. Traditionally, because the armrest is mainly used by a driver, it is configured to be opened unidirectionally from the front to the rear. However, by various requests, Korean Utility Model Application No. 20-1994-0031556 (filed on Nov. 28, 1994) and Korean Patent Application No. 10-2004-0097620 (filed on Nov. 25, 2004) proposed armrest configured to be selectively opened from the front or the rear.

Besides the above, recently, products capable of being selectively opened and closed on both sides have been disclosed. However, such conventional arts are complicated in structure and it is difficult to implement realistically. In addition, in the case that the armrest is selectively opened or closed at the front or rear, there is no countermeasures for various disadvantages that could happen in the actual use.

### SUMMARY OF THE INVENTION

Accordingly, the present invention has been made in view of the above-mentioned problems occurring in the prior art, and it is an object of the present invention to provide an armrest having side lids capable of structurally supporting a center lid which is opened and closed around a hinge shaft with enough strength.

In particular, in the case that the armrest is configured to be opened and closed bidirectionally, the side lids supporting the center lid have sufficient structural strength and convenience.

To accomplish the above object, according to the present invention, there is provided an armrest for a vehicle including: a center lid for opening and closing a storage box; and a pair of side lids for supporting the opening and closing of the center lid on both sides of the center lid. The side lid includes: an outer cover mounted on the outside; and an inner cover mounted on the inside, formed in a longitudinal direction, and having a horizontal protrusion protruding inward. Here, at least a part of the center lid is positioned on the horizontal protrusion.

According to another embodiment of the present invention, the side lid further includes a metal frame fixed and supported between the inner cover and the outer cover.

According to another embodiment of the present invention, the frame includes: an upper frame fixed and supported between the inner cover and the outer cover; a lower frame supported on the outer surface of the storage box; and a connection unit connecting the upper frame and the lower frame.

According to a preferred embodiment of the present invention, the inner cover forming the inner part of the upper lid covers various components arranged between the outer cover and the outer cover and the inner shape of the outer cover. Therefore, the armrest according to the present invention has an advantage of forming the inside of the armrest which is aesthetically clean.

Moreover, the inner cover according to the present invention has the horizontal protrusion which is continuously formed in the back-and-forth direction to protrude inward. The horizontal protrusion can reinforce the structural strength of the inner cover, and at least a part of the center lid which is opened and closed is located on the horizontal protrusion. Therefore, the armrest according to the present invention can easily perform initial opening of the center lid by the push member, and provide sufficient structural strength against an external force by the center lid.

According to the present invention, the inner cover and the outer cover are designed to be supported by the metal frame. Due to the frame, it is expected that the structural strength of the storage box and the armrest can be sufficiently secured. Additionally, based on the structure of the metal frame, it is expected the present invention can provide a console which is stronger and more reliable when the armrest is configured to be opened and closed bidirectionally.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a view illustrating a console to which the present invention is applied;

FIG. 2 is an exploded perspective view of a side lid of the present invention;

FIG. 3 is a perspective view illustrating a frame supporting the side lid of the present invention; and

FIG. 4 is a perspective view illustrating an assembled state of the side lid of the present invention.

### DETAILED DESCRIPTION OF THE PREFERRED EMBODIMENT

Hereinafter, the present invention will be described in more detail with reference to the embodiment illustrated in the drawings.

A console installed between a driver seat and a passenger seat in a vehicle includes: a storage box S which can be referred to as a storage space; and an armrest A for opening and closing an open portion of the upper end of the storage box. The armrest A is installed on the top of the storage box S and is used to open and close the storage space of the storage box S.

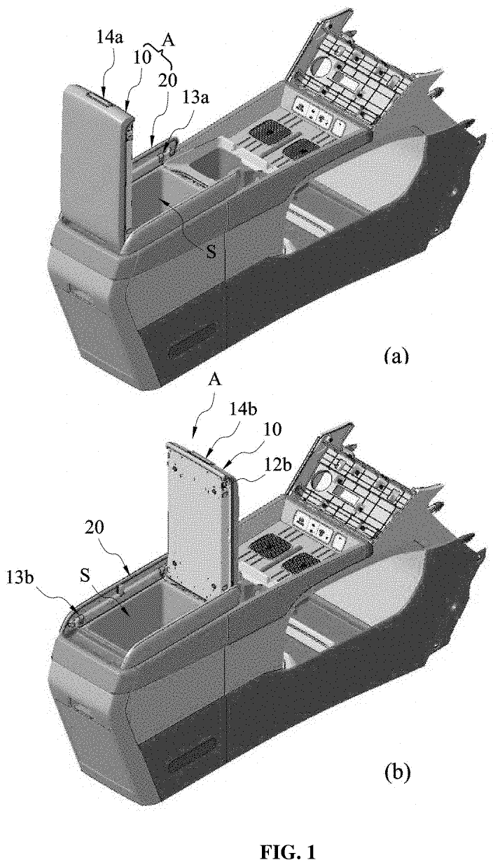

Furthermore, as illustrated in FIG. 1, the armrest A according to the present invention includes: a center lid 10 for opening and closing a storage space; and a pair of side lids 20 fixed to an upper portion of the storage box S to support the opening and closing of the center lid 10. The armrest A of the present invention can more preferably make the center lid 10 selectively opened and closed in any one direction among forward and backward directions.

FIG. 1(a) illustrates the center lid 10 opened backward, and FIG. 1(b) illustrates the center lid 10 opened forward. Here, to be selectively opened and closed forward and backward substantially means to be selectively opened and closed bidirectionally. Additionally, when the center lid 10 of the armrest is closed, a locked state is maintained.

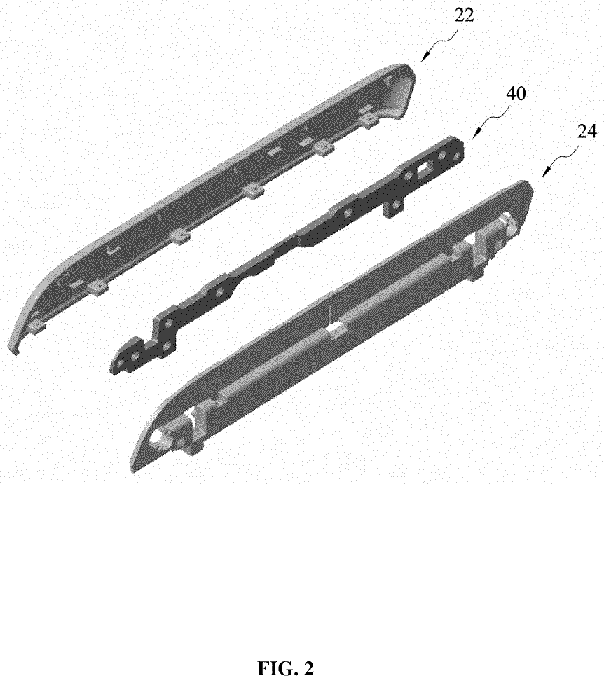

For instance, in the case that the center lid 10 is configured to be opened and closed bidirectionally, when release buttons 12 respectively mounted at front and rear ends of the center lid 10 are pressed selectively, the locked state of the center lid 10 is released, and a certain section of the center lid 10 is opened. In this instance, the side lids 20 mounted at both sides of the upper portion of the storage box S support the opening and closing of the center lid 10. The exploded view of FIG. 2 illustrates the configuration of the side lid 20.

As illustrated in FIG. 2, each of the side lids 20 includes an outer cover 22 and an inner cover 24. A part of a frame 40 which is made of a metallic material, for instance, aluminum diecasting, is interposed between the outer cover 22 and the inner cover 24. Moreover, the frame 40 connects and supports the storage box S and the side lid 20 to provide sufficient strength.

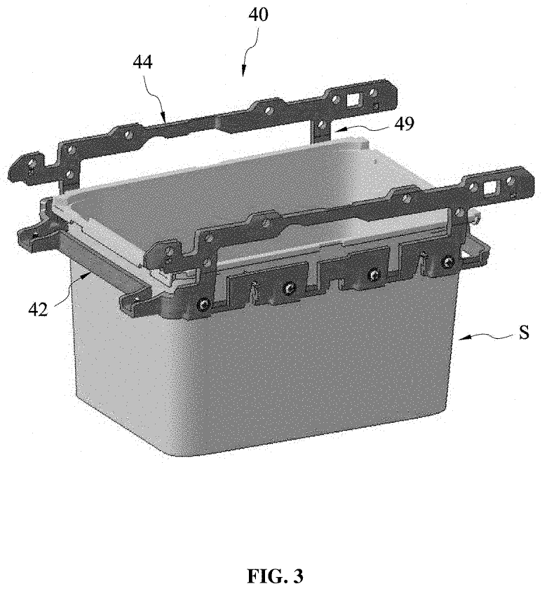

As illustrated in FIG. 3, the frame 40 includes a lower frame 42 fixed to the storage box S, and an upper frame 44 extending upward from the lower frame 42 and supporting the side lid 20. The upper frame 44 is interposed between the inner cover 24 and the outer cover 22 of the side lid 20.

In other words, the outer cover 22 and the inner cover 24 are respectively fixed to both sides of the upper frame 44, for example, by bolts or the likes. Therefore, the upper frame 44 is also one element constituting the side lid 20. The entire of the frame 40 is preferably made of aluminum diecasting. As such, the upper frame 44 ultimately supports the side lids 20 of both sides.

Additionally, the lower frame 42 constituting the lower part of the frame 40 is formed in a rectangular shape to surround the side surface of the storage box S. The lower frame 42 is also fixed to the storage box S by using bolts or the likes. The upper frame 44 is disposed to face each other on both sides where the side lids 20 are mounted, and is connected to the lower frame 32 through a connection part 49.

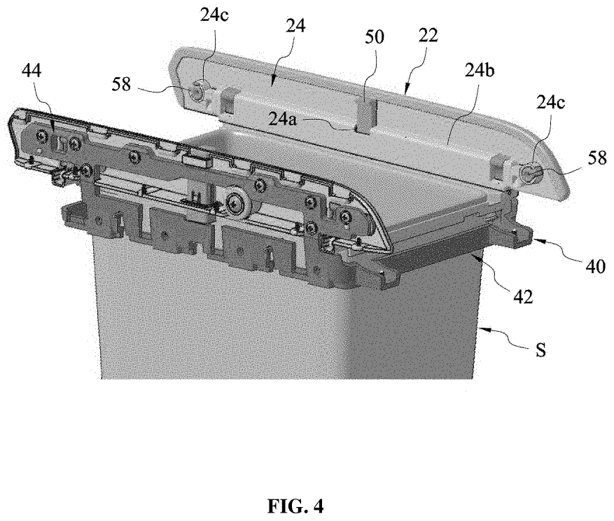

Next, referring to FIG. 4, the inner cover 24 of the side lid 20 will be described. The side lid 20 includes a push member 50 supported upward by an elastic member, such as a spring. The push member 50 is to push the center lid 10 upward to a predetermined height when the release button 12 is pushed to release the locked state in the state in which the center lid 10 of the armrest is closed to be locked, and is mounted in the middle of the side lid 20.

That is, the push member 50 is mounted in the middle of the side lid 20, and the side lid 20 receives elastic force upwards by a spring. Therefore, when the locking force which closes the center lid 10 is removed, the push member 50 lifts the center lid 10 slightly upward, and it is called ‘initial opening’ The push member 50, as illustrated in FIG. 3(a), is supported to be movable in the vertical direction in a state in which the push member protrudes inward through a through hole 24a formed in the inner cover 24.

As illustrated in FIG. 4, the through hole 24a is formed on the horizontal protrusion 24b of the inner cover 24. Here, the horizontal protrusion 24b substantially has a stepped portion since being formed at the height of a middle part of the inner cover 24 in the back-and-forth direction to have a predetermined length. At least a part of the center lid 10 is located on the horizontal protrusion 24b. Therefore, the initial opening will progress by the push member 50.

As described above, the horizontal protrusion 24b extending in the back-and-forth direction substantially functions as a rib for reinforcing structural strength. Moreover, because protruding in the inner horizontal direction, the horizontal protrusion part 24b is also referred to as a supporter against the external force acting on the center lid 10. In addition, since being made with one component, the inner cover 24 according to the present invention has an aesthetic function covering a plurality of components mounted between the outer frame 40 and the outer cover 22.

The push member 50 is supported to be movable in the vertical direction on the inner cover 24. For example, the push member 50 is supported to linearly move in the vertical direction by a guide 52 having a vertically tubular shape mounted on the inner cover 24. In addition, it would be easily understood by those skilled in the art that there are various embodiments of the push member 50, which is guided to move vertically by the inner cover 24.

In the embodiment illustrated in the drawings, an end portion of a torsion spring 48 is configured to push the push member 50 upward, but the present invention is not limited thereto, and it is natural to elastically support the push member 50 upward using the elastic force of various types of the spring. As described above, the push member 50 is mounted on the side lid 20 to be movable in the vertical direction and is elastically supported upward by the elastic member.

According to an embodiment of the present invention, the inner cover 24 is supported by an upper frame 44. Here, the frame 40 includes the lower frame 42, which has a rectangular shape when viewed on the plane figure and is supported on the storage box S. Furthermore, the inner cover 24 and the outer cover 22 are respectively fixed to the inner side and the outer side of the upper frame 44 by bolts or the likes. The lower frame 44 is fastened to the storage box S by using a fastening (fixing) element, such as, a bolt.

The lower frame 44 made of aluminum diecasting has a substantially rectangular shape and is supported on the outer surface of the storage box S while being in close contact with the outer surface of the storage box S. The upper frame 44 functions to support the outer cover 22 and the inner cover 24 while forming a part of the side lid 20. Here, the frame 40 has sufficient structural strength since being formed of a metal material, thereby sufficiently and firmly supporting the armrest (center lid) opened and closed with respect to the fixed storage box S.

Additionally, the inner cover 24 has a plurality of open portions, and the through hole 24a described above is one of the open portions. In addition, a hinge shaft passing part 24c which covers a hinge shaft bush 58 for supporting the hinge shaft when the center lid 10 is opened or closed is substantially formed as the open portion. The hinge shaft bush 58 made of a synthetic resin material passing through the hinge shaft passing part 24c is substantially supported by the upper frame 44.

As described above, the armrest according to the present invention of which a portion is opened and closed since the inner cover, which is a portion of the side lid 20, is designed optimally, provides a firm support structure and an aesthetic appearance. Moreover, like the outer cover, the inner cover is designed to be supported by the metal frame, thereby securing sufficient structural strength.

What is claimed is:

1. An armrest for a vehicle comprising:
a center lid for opening and closing a storage box; and
a pair of side lids for supporting the opening and closing of the center lid on both sides of the center lid,
wherein the side lid comprises an outer cover mounted on the outside, and an inner cover mounted on the inside formed in a longitudinal direction, and having a horizontal protrusion protruding inward, and
wherein at least a part of the center lid is positioned on the horizontal protrusion.

2. The armrest according to claim 1, wherein the side lid further comprises a metal frame fixed and supported between the inner cover and the outer cover.

3. The armrest according to claim 2, wherein the frame comprises: an upper frame fixed and supported between the inner cover and the outer cover; a lower frame supported on the outer surface of the storage box; and a connection unit connecting the upper frame and the lower frame.
